(19) United States
(12) Patent Application Publication
(10) Pub. No.: US 2002/0163184 A1
(43) Pub. Date: Nov. 7, 2002

(54) Method and apparatus for securing a connection

(76) Inventor: James Blair, Lake Carroll, IL (US)

Correspondence Address: WOOD, PHILLIPS, VAN SANTEN,, CLARK & MORTIMER, Suite 3800, 500 West Madison Street, Chicago, IL, 60661, US

(21) Appl. No.: 09/849,686

(22) Filed: May 4, 2001

(51) Int. Cl. F16L 13/04

(52) U.S. Cl. 285/114

(57) ABSTRACT

The problem of securing a connection in a mechanical structure. fluid line, or electrical line, that can not readily be secured by traditional lock-wiring techniques, is solved through a method and apparatus for securing a connection with a commonly available commercial lanyard and a lanyard retainer. The lanyard retainer has an elongated center section adapted for positioning the retainer adjacent the connection, and means at both ends of the retainer for engaging and retaining the lanyard.

### FIELD OF THE INVENTION

This invention is directed to a method and apparatus for securing a connection in a mechanical structure, fluid line, or electrical line, and particularly to a method and apparatus for securing connections that cannot readily be secured by traditional lock-wiring techniques.

### BACKGROUND OF THE INVENTION

It has long been the practice to provide a secondary means for securing connections in mechanical structures, fluid lines, or electrical lines, to preclude undesired or inadvertent separation of the connection during operation. Often this involves a process known as lock-wiring.

For typical connections made with a connecting device having a rotating part, a length of lock-wire, passed through holes in a rotating part and secured to a non-rotating portion of the connecting device or a nearby stationary structure, is used to prevent the rotating part from loosening during operation in a way that would allow the connection to separate.

In connections that have no rotating parts, connections are similarly lock-wired by feeding a length of lock-wire through holes in mating halves of the connecting device, and securing the mating halves to one another by twisting the free ends of the lock-wire together in a manner that prevents the mating parts from separating from one another.

To ensure that the lock-wire is properly installed, and to allow a particular routing of lock-wire for a given connection to be standardized and inspected, the routing is generally recorded on process drawings, and lock-wire pliers are typically utilized for tightly twisting and positioning the lock-wire between the holes in the connecting device and any point of attachment to supporting structure. Some connections are so small, or inaccessible, however, that it is not possible to use traditional lock-wiring techniques as described above. For these connections, other securing methods and apparatus are required.

It is an object of my invention to provide an improved apparatus and method for securing connections. It is also an object of my invention to provide a securing method and apparatus that does not require passing lock-wire through holes in connecting devices. It is a further object of my invention that the improved securing method and apparatus be applicable to a wide variety of connections, including those that do not have rotating parts. Another object of my invention is to provide a method and apparatus for securing a connection without using tools. It is also an object of my invention to provide an improved securing method and apparatus that can be readily duplicated and inspected on multiple connections to optimize manufacturing and quality control operations.

### SUMMARY OF THE INVENTION

My method and apparatus for securing a connection achieve the above objects through the use of a commonly available commercial lanyard, and a lanyard retainer. The lanyard retainer has an elongated center section adapted for positioning the retainer adjacent the connection, and means at both ends of the retainer for engaging and retaining the lanyard.

In one form of my invention, a connection, formed by a first and a second connector half mating with one another along an axis of connection to join a first and a second line extending respectively from the first and second connector halves, is secured by positioning the lanyard retainer generally along the axis of connection with the first end of the retainer adjacent the first connector half and a second end of the retainer adjacent the second connector half. A first end of a lanyard is then passed about the first connector half, and/or the first line extending from the first connector half, to form a first loop in the lanyard which is secured to the first end of the retainer. The free end of the lanyard extending from the first loop is then routed at least partially along the axis of connection, and passed about the second connector half, and/or the second line extending from the second connector half, to form a second loop in the lanyard which is secured to the second end of the retainer. With the retainer securing the lanyard about the connection in this manner, the first and second connector halves are precluded from moving with respect to one another along the axis of connection, thereby securing the connection against separation.

In a preferred form of my invention, the lanyard is a commercially available wire cable of small diameter having a metal block larger than the cable diameter welded, swaged, cast or otherwise permanently affixed to a first end of the lanyard. The retainer is formed from a length of wire having an elongated central section adapted for positioning the retainer adjacent a connection formed by a first and a second connector half mating with one another along an axis of connection, with a first end of the retainer adjacent the first coupling half and a second end of the retainer adjacent the second connector half.

The first end of the retainer is formed into a helical spring with a central opening defining a first eye of the retainer. The first eye is sized to allow a free end of the lanyard extending from the metal block to pass through the first eye twice, to form a first loop in the lanyard. The first eye is too small to allow the metal block of the lanyard to pass through, however, so that the first loop in the lanyard can be tightened like a noose, around the first connector half, by pulling on the free end of the lanyard. The second end of the retainer is formed into a helical spring having closely spaced or abutting coils, adapted for gripping the lanyard between the coils. The closely spaced coils also form a central opening, defining a second eye of the retainer, for passage of the lanyard.

To secure a connection, the retainer is positioned adjacent the connection. The lanyard is looped and tightened around the first end of the connector. The free end of the lanyard is then routed along the axis of connection, looped around the second end of the connection one or more times, and the free end is secured by passing it though the second eye and pulling it between the coils of the helical spring at the second end of the retainer to secure the lanyard and the connection.

The specific routing of the lanyard for each type of connection can be varied for optimal installation and security. Once a preferred routing is established, it can be recorded in a series of photographs or process drawings, so that the routing can be duplicated and readily inspected for quality control when securing similar connections.

Other forms, aspects and advantages of my invention will be apparent upon review of the following detailed description and attached drawings.

### BRIEF DESCRIPTION OF THE DRAWINGS

FIG. 1 depicts a fluid connector secured with a securing device according to my invention;

FIG. 2 depicts an electrical connector secured with a securing device according to my invention;

FIG. 3 depicts a lanyard retainer of a securing device according to my invention;

FIGS. 4 and 5 are partial views of the lanyard retainer of FIG. 3, viewed as indicated by arrows 4 and 5 respectively in FIG. 3; and

FIGS. 6a-n depict a series of steps in a method of securing a connection using a securing device according to my invention.

### DETAILED DESCRIPTION OF THE PREFERRED EMBODIMENT

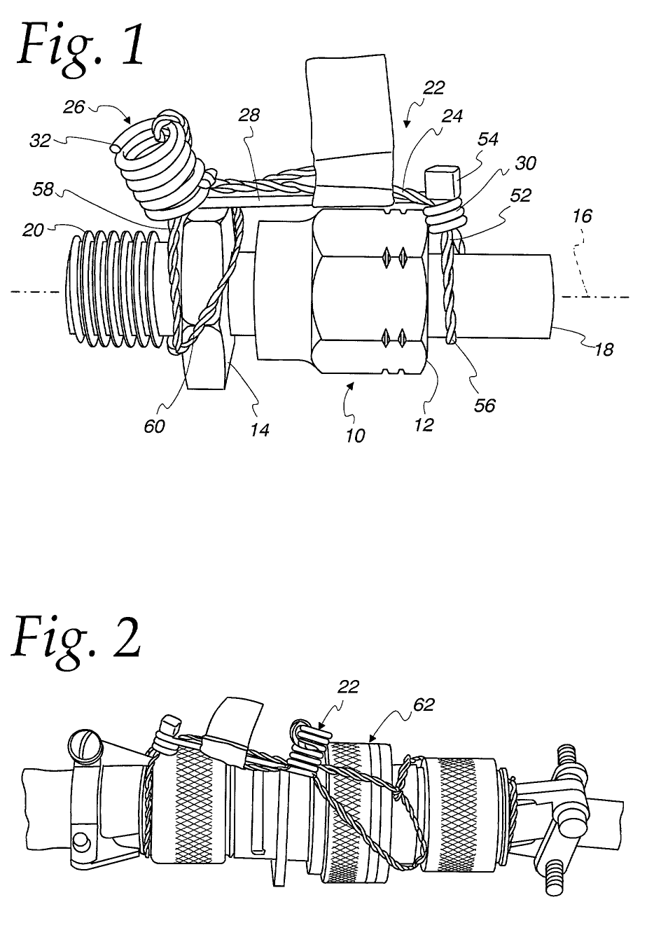

FIG. 1 depicts a connection formed by a first and second connector half 12, 14 mating with one another along an axis of connection 16 to join a first and second fluid line 18, 20 extending respectively from the first and second connector halves 12, 14. The connection 10 is secured with a securing device, generally designated 22, comprising a lanyard 24, and a lanyard retainer, generally designated 26. The lanyard retainer 26 has an elongated central “leg” section 28 adapted to position the retainer 26 generally along the axis of connection 16, with a first end 30 of the retainer 26 adjacent the first connector half 12, and a second end 32 of the retainer 26 adjacent the second connector half 14.

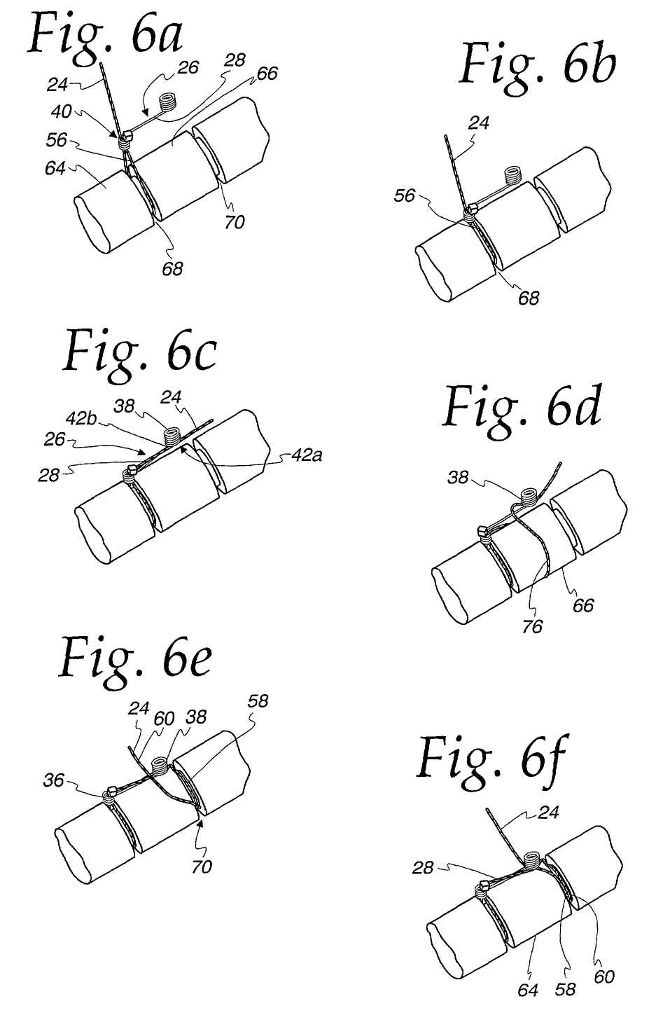

As shown in FIGS. 3-5, the lanyard retainer 26, in the embodiment of my invention depicted in FIG. 1, is formed from a continuous length of resilient wire having a central linear section forming the elongated central body, or leg 28 of the retainer 26, and defining a longitudinal axis 34 of the retainer 26. The first and second ends 30, 32 of the retainer 26 are terminated in first and second helical springs 36, 38.

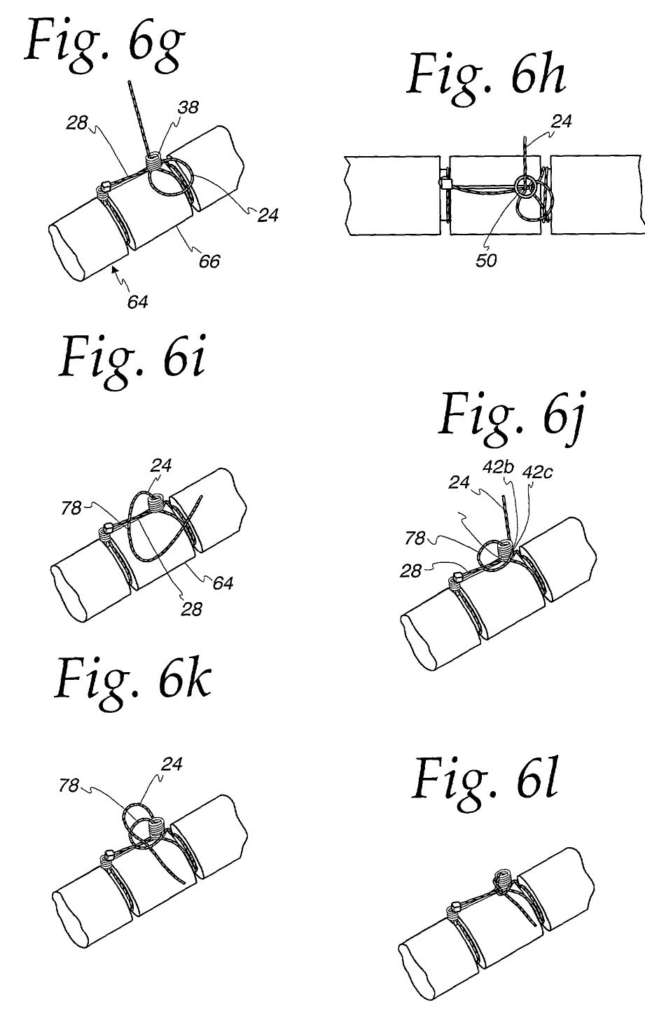

As shown in FIG. 4, the first helical spring 36 at the first end 30 of the retainer 28 provides a means for retaining one end of the lanyard 24 by having the coils 44 configured to define a first eye 40 adapted for receiving and retaining the first end of the lanyard 24. The second helical spring 38 at the second end 32 of the retainer 26 has closely spaced coils 42a-g for gripping the lanyard 24 between adjacent coils.

The first helical spring 36, at the first end 30 of the retainer 26, has a series of coils 44 wound at a first radius R₁ about a first winding axis 46 which is oriented substantially perpendicular to the longitudinal axis 34 of the retainer 26. The first winding axis 46 is spaced a distance of R₁ from the leg 28 such that the linear section 28 joins smoothly with a first one of the coils 44 at the first end 30 of the linear section 28, and such that the linear section 28 does not pass through the eye 40 of the coils 44 of the first helical spring 36 of the retainer 26.

As shown in FIGS. 3 and 5, the closely spaced coils 42a-g of the second helical spring 38 are wound at a second radius R₂ about a second winding axis 48 oriented substantially perpendicular to the longitudinal axis 34 of the retainer 26 and passing through the longitudinal axis 34. In contrast to the first helical spring 36 as described above, the leg 28 of the retainer passes beneath the coils 42a-g at the second end 32 of the retainer to substantially bisect a second eye 50 formed by the coils 42a-g of the second helical spring 38, and joins smoothly with the first coil 42a in a third radius R₃ which is smaller than the second radius R₂.

By virtue of this winding arrangement, the first coil 42a of the second spring 38 is really only a “half-coil.” When viewed from the bottom as shown in FIG. 5, therefore, both the first half coil 42a, and a portion of the second coil 42b are visible on alternate sides of the leg 28. With this arrangement, the free end of a lanyard 24 extending along and below the leg 28 as depicted in FIG. 5 can be easily pulled between the first coil 42a and the second coil 42b, to secure the free end of the lanyard. The configuration of the first coil 42a and leg 28 of the retainer 26 thus act as a guide to facilitate pulling the lanyard 24 between the first and second coils 42a, 42b.

For reasons that will be evident from the discussion below, the radius R₁ of the coils 44 of the first helical spring 36 is smaller than the radius R₂ of the coils 42a-g of the second helical spring 38.

In the retainer 26 depicted in FIGS. 1-5, the coils 44, and 42 are wound in opposite directions about their respective winding axes 46, 48, and the first and second winding axes 46, 48 are oriented substantially parallel to one another to facilitate winding of the helical springs 36, 38. Other winding arrangements and orientations of the helical springs may be more or less advantageous in other forms of a lanyard retainer in accordance with my invention, and are contemplated within the scope of the appended claims. I also contemplate lanyard retainers in accordance with my invention in which the elongated central body may be neither linear nor substantially straight, and wherein the first end 30 of the retainer may be configured in some manner other than a helical spring 36.

As shown in FIG. 1, the lanyard 24 is a commercially available wired cable 52 of small diameter, having a metal block 54 larger than the diameter of the cable 52 welded, swaged, cast, or otherwise permanently affixed to a first end of the lanyard 24. The Radius R₁ of the first helical spring 36 is sized to form an eye 40 which will allow the free end of the lanyard 24 extending from the metal block 54 to pass through the first eye 40 twice to form a first loop 56 in the lanyard 24. The first winding radius R₁ is selected to form a first eye 40 which is too small, however, to allow the metal block 54 of the lanyard 24 to pass through the first eye 40, so that the first loop 56 of the lanyard 24 can be tightened like a noose around the first connector half 12, or around the first line 18, by pulling on the free end of the lanyard 24. After tightening the first loop 56, the free end of the lanyard 24 is routed along the leg 28 of the lanyard retainer 26 passed and beneath the first coil 42a of the second helical spring 38 and secured between the first and second coils 42a, 42b of the spring 38. The free end of the lanyard 24 is then passed one or more times above the second connector half 14, and/or the second line 20 extending from the second connector half, to form a second loop 58, and possibly a third loop 60, in the lanyard, and the free end is secured by pulling it between and wrapping it around and between the coils 42a-g of the second end of the retainer 26.

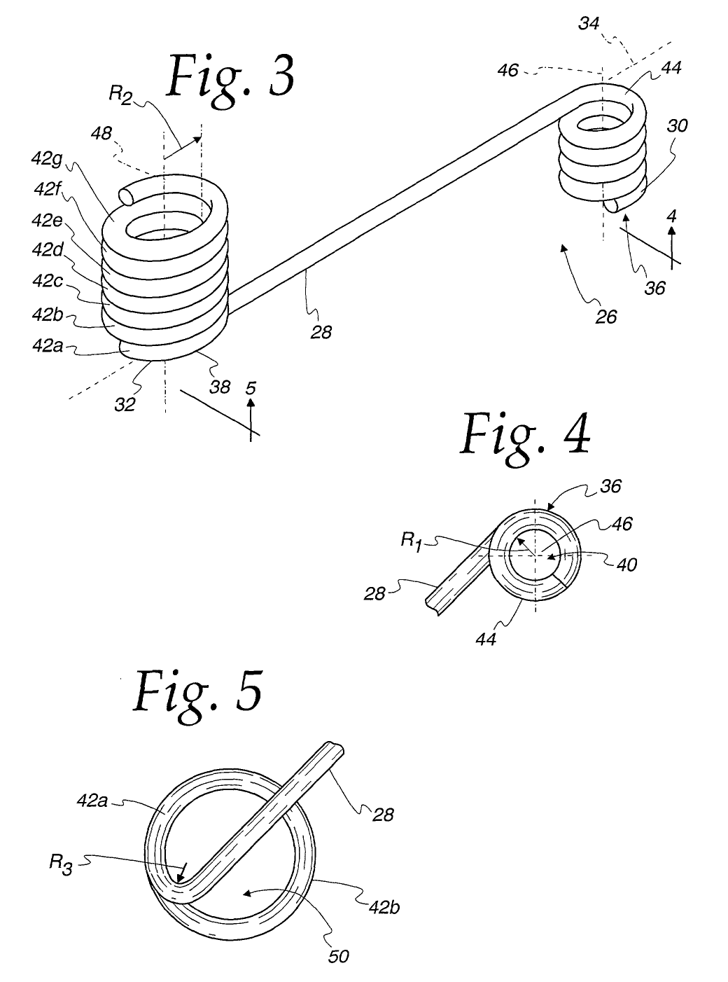

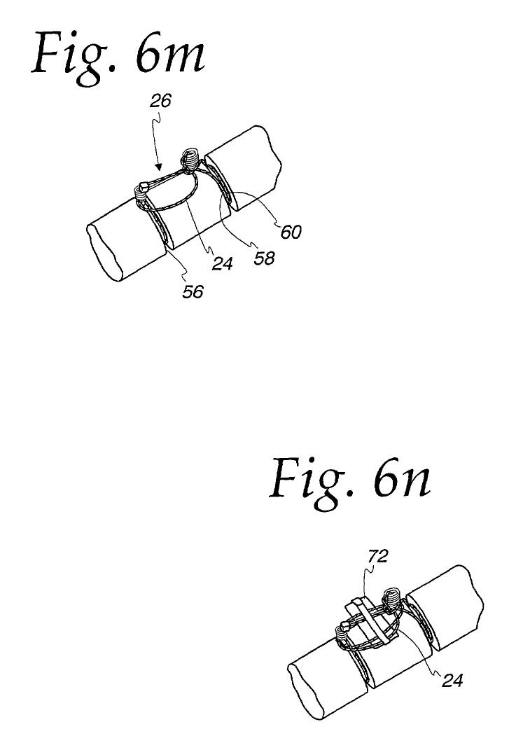

The exact routing of the lanyard 24, the number of times the lanyard 24 is wrapped about the second connector half 14, and/or any intermediate connector parts, will vary depending upon the type of connection being secured. FIG. 2 for instance, illustrates an application of a retaining device 22, as described above with relation to FIGS. 1 and 3-5, applied to an electrical connector 62. As will be understood by comparing FIGS. 1 and 2, the particular manner in which a securing device 22 according to my invention is configured and applied to secure a given connection, will vary depending upon the configuration of the connection and its component parts. Those skilled in the art will readily recognize, however, that a securing device according to my invention provides a convenient means and method for securing a connection without the use of tools, and provides a means and method of securing connection which may not be amenable to traditional lock-wiring techniques FIGS. 6a-n depict a series of steps which may be utilized for securing a connection of the type shown in FIGS. 1 and 2. To facilitate clarity in the illustrations, the “connection” in FIGS. 6a-n, is simulated by a cylinder 64 having a central section 66 depicting a connection extending between a first and a second annular groove 68, 70 respectively depicting a first and second line to be joined by the simulated connector 66. This clarifies the illustrations by omitting non essential detail of the connecting elements.

As shown in FIG. 1, the retainer 26 is positioned with the leg 28 extending along the central section 66. The free end of the lanyard 24 is inserted downward through the first eye 40 of the retainer 26, and then wrapped around the groove 68 and passed back up through the first eye 40 to form a first loop 56 of the securing device 22. As shown in FIG. 6b, the free end of the lanyard 24 is then pulled to seat the first loop 56 tightly in the annular groove 68, removing all excess slack from the lanyard 24. As shown in FIG. 6c, the free end of the lanyard 24 is then extended along the leg 28 of the retainer 26 and under the first coil 42a of the second helical spring 38 of the retainer 26. With a firm pull, the free end of the lanyard 24 will “snap-in” between the first and second coils 42a, 42b of the second helical spring 38.

Optionally, as shown in FIG. 6d, an extra half-hitch 76 can be made around the connection (central section 66) to grip the central section and hold it against rotation. If this extra half-hitch 76 is used, it is made before extending and securing the free end of the lanyard 24 to the second helical spring 38, as shown in FIG. 6c. For clarity of illustration, this optional half-hitch 76 is not illustrated in FIGS. 1 and 2, or in FIGS. 6a-c and FIGS. 6e-n.

As illustrated in FIG. 6e the free end of the of the lanyard 24 is then wrapped twice in a clockwise direction around the connection within the second annular groove 70 to form a second loop 58 and a third loop 60. At the completion of the second wrap of the free end of the lanyard 24, the free end is positioned along the leg 28 at a point between the first and second helical springs 36, 38, and just to the left of the second helical spring 38 as depicted in FIG. 6e. As shown in FIG. 6f, the free end of the cable is then continued across the leg 28 and fed under the second or third loop 58, 60, on the backside of the cylinder 64, and pulled firmly to remove all slack. By virtue of the construction of the retainer 26, the free end of the lanyard 24 will engage both loops 56 and 60 and be pulled between the first and second coils 42a, 42b of the spring 38 to form a locking point.

As shown in FIG. 6g, the free end of the lanyard 24 is then looped in a clockwise direction around the outside of the second helical spring 38 and passed under the leg 28 between the leg 28 and the central section 66 of the cylinder 64, and the free end is pulled to remove all slack from the lanyard 24. The free end of the lanyard is then fed upward from the bottom of the second helical spring 38 through the second eye 50 as shown in FIG. 6h. The free end of the lanyard 24 is pulled completely through the second eye 50, as shown in FIG. 6i and inserted under the leg 28 from the far side of the cylinder 64 to form a loop 78 extending out 20 from the top of the second helical spring to the underside of the leg 28. The free end of the lanyard 24 is then inserted between the second and third coils 42b-c of the second helical spring 38 as shown in FIG. 6j, but the loop 78 thus formed is not pulled tight.

As shown in FIG. 6k, the free end of the lanyard 24 is then inserted through the loop 78 formed as shown in FIGS. 6i and 6j and above the leg 28, and the free end of the lanyard 24 is pulled firmly to tighten the loops and remove all slack from the cable as shown in FIG. 6l.

At this point, the connection is fully secured, and any excess length of the lanyard 24 can be trimmed off. Alternatively, any excess length of the lanyard 24 may be woven around the retainer 26 and through the loops 56, 58, 60, as shown in FIG. 6m.

In some applications, it may also be desirable to install an identification tag 72, which can also be used to secure the free end of the lanyard 24, as shown in FIG. 6n. In such applications, it is not intended that the identification tag 72 function as a locking device.

Although I have provided a number of exemplary embodiments in the preceding discussion, and accompanying drawings those having skill in the art will recognize that my invention may be practiced in many alternate forms within the scope of the appended claims. It is understood, therefore, that the spirit and scope of the appended claims should not be limited to the specific embodiments described and depicted herein.

1. A lanyard retainer comprising:
an elongated central body terminating at a first end thereof in means for retaining one end of said lanyard, and terminating at a second end thereof in a helical spring having closely spaced coils for gripping said lanyard between said coils.

2. The lanyard retainer of claim 1 wherein said means for retaining comprises an eye at said first end of said elongated central body for passage therethrough of said lanyard.

3. The lanyard retainer of claim 2 wherein said first end is configured as a helical spring having a central opening forming said eye of said loop.

4. The lanyard retainer of claim 1 wherein said retainer is formed from a continuous length of wire having said first and second ends thereof terminating in helical springs;
said helical spring at said first end including coils defining an eye adapted for receiving and retaining a first end of said lanyard, and said helical spring at said second end having closely spaced coils for gripping said lanyard between said coils.

5. The lanyard retainer of claim 4 wherein:
said elongated central body is a linear section of said length of wire defining a longitudinal axis of said retainer;
said coils of said first end are wound at a first radius R₁ about a first winding axis oriented substantially perpendicularly to said longitudinal axis of the retainer but spaced a distance of R₁ therefrom such that said linear section joins smoothly with a first one of said coils at said first end and said linear section does not pass through said eye of said loop; and
said closely spaced coils at said second end are wound at a second radius R₂ about a second winding axis oriented substantially perpendicularly to said longitudinal axis of the retainer and passing through said longitudinal axis, with said linear section passing beneath said coils at said second end and substantially bisecting said second eye and joining smoothly with a first one of said coils at said second end in a third radius R₃ which is smaller than said second radius R₂.

6. The lanyard retainer of claim 5 wherein the radius R₁ of the coils at said first end is smaller than the radius R₂ of the coils at said second end.

7. The lanyard retainer of claim 5 wherein the coils at said first and second ends are wound in opposite directions about their respective winding axes.

8. The lanyard retainer of claim 5 wherein said first and second winding axes are oriented substantially parallel to one another and coils at said first and second ends of said retainer extend in opposite directions from said longitudinal axis of said retainer.

9. The lanyard retainer of claim 8 wherein the coils at said first and second ends are wound in opposite directions about their respective winding axes.

10. The lanyard retainer of claim 5 wherein said linear section is substantially straight.

11. The lanyard retainer of claim 2 wherein said eye is adapted to allow passage therethrough of said lanyard, but small enough to prevent passage therethrough of a termination block affixed to an end of said lanyard.

12. A securing device for a connection formed by a first and a second connector half mating with one another along an axis of connection to join a first and a second line extending respectively from said first and second connector halves, said securing device comprising:
a lanyard;
and a lanyard retainer having an elongated central section adapted to position said retainer along said axis of connection with a first end of said retainer adjacent said first coupling half and a second end of said retainer adjacent said second connector half, said first and second ends of said retainer having means for engaging and retaining said lanyard.

13. The securing device of claim 12 wherein said first end of said retainer is adapted to receive and retain a first loop formed in said lanyard and passing around said first connector half or said first line extending therefrom, and said second end of said retainer is adapted to receive and retain a second loop formed in said lanyard and passing around said second connector half or said second line extending therefrom.

14. The securing device of claim 12 wherein said second end of said retainer comprises a helical spring having a plurality of closely spaced coils for gripping said lanyard between said coils.

15. The securing device of claim 14 wherein said helical spring at second end of said retainer is further adapted to define a second eye for passage therethrough of said lanyard.

16. The securing device of claim 12 wherein said lanyard includes an enlarged portion at a first end thereof, and said first end of said retainer defines an eye adapted to provide passage therethrough of said first loop, but preventing said enlarged end portion of said first end from passage therethrough, said eye, first loop, and enlarged end portion thereby forming a noose which can be tightened about said first connector half and/or said first line extending from said first connector half.

17. A method for securing a connection formed by a first and a second connector half mating with one another along an axis of connection to join a first and a second line extending respectively from said first and second connector halves, said method comprising:
positioning a lanyard retainer along said axis of connection with a first end of said retainer adjacent said first coupling half and a second end of said retainer adjacent said second connector half;
passing a first end of a lanyard about said first connector half and/or said first line extending therefrom to form a first loop in said lanyard and securing said first loop to said first end of said retainer;
routing a free end of said lanyard extending from said first loop at least partially along said axis of connection; and
passing said free end about said second connector half and/or said second line extending therefrom to form a second loop in said lanyard and securing said second loop to said second end of said retainer.

18. The method of claim 17 wherein said first end of said lanyard terminates in an enlarged portion thereof, and said first end of said retainer defines an eye adapted to provide passage therethrough of said first end of said lanyard to form said first loop, but preventing said enlarged portion of the first end from passage therethrough, and said step of passing said first end about said first connector half and/or first line includes passing said first end of said lanyard through said first eyes twice to form said first loop in a noose-like fashion and pulling said free end of said lanyard through said first eye to thereby tighten said first loop about said first connector half and/or said first line extending from said first connector half.

19. The method of claim 17 wherein said second end of said retainer comprises a helical spring having a plurality of closely spaced coils for gripping said lanyard between said coils, and said step of securing said second loop in said lanyard includes gripping the free end lanyard between said coils.

20. The method of claim 19 wherein said helical spring at sais second end of said retainer is further adapted to define a second eye for passage therethrough of said lanyard, and said step of securing said second loop to said second end of said retainer includes passing said free end of said lanyard through said second eye.
